(19) United States
(12) Patent Application Publication
(10) Pub. No.: US 2009/0240429 A1
(43) Pub. Date: Sep. 24, 2009

(54) METHOD FOR ROUTE PLANNING ON A NAVIGATION SYSTEM INCLUDING POINTS OF INTEREST

(75) Inventors: Katsuaki Tanaka, West Bloomfield, MI (US); Deepak Ramaswamy, Superior Township, MI (US)

Correspondence Address: GIFFORD, KRASS, SPRINKLE,ANDERSON & CITKOWSKI, P.C, PO BOX 7021, TROY, MI, 48007-7021, US

(73) Assignee: Xanavi informatics Corporation, Kanagawa-Ken (JP)

(21) Appl. No.: 12/051,314

(22) Filed: Mar. 19, 2008

(51) Int. Cl. G01C 21/36; G06F 17/30

(52) U.S. Cl. 701/202; 707/104.1; 707/E17.018

(57) ABSTRACT

A method for route planning for use with a vehicle navigation system. The method includes the steps of inputting a route origin and route destination on a computer separate from the navigation system, such as a PC. The user also inputs activities or points of interest. The computer then searches a point of interest database which matches the activities inputted by the user and calculates a preferred route from the origin and to the route destination. The preferred route, together with data relating to the points of activity, are then wirelessly transmitted to the navigation system for subsequent display on the navigation system screen.

### BACKGROUND OF THE INVENTION

I. Field of the Invention

The present invention relates generally to a method for route planning for use with a vehicle navigation system.

II. Description of Related Art

Automotive navigation systems have become increasingly popular in modern automotive vehicles. Such navigation systems include a screen display mounted within the vehicle passenger compartment in a position visible to the occupants of the vehicle. Typically, a roadmap is displayed on the screen from an internally accessible map database while the position of the automotive vehicle is also displayed on the screen, usually through a GPS system.

Early vehicle navigation systems typically did little more than calculate and display a preferred route, typically the quickest route, between an origin or position of the vehicle and a user inputted destination. However, as the vehicle navigation systems have developed, more recent navigation systems are capable of displaying points of interest on the navigation screen to the vehicle occupants. These points of interest may include, for example, restaurants, sport activities, tourist attractions, museums, and the like.

Even though the more modern vehicle navigation systems have been able to display points of interest along the route, these navigation systems have not been able to provide route planning for the vehicle operator which enhances the enjoyment of a particular trip for the vehicle occupants.

### SUMMARY OF THE PRESENT INVENTION

The present invention provides both a method and apparatus for route planning for a vehicle navigation system which overcomes the above-mentioned disadvantages of the previously known methods and systems.

In brief, the present invention utilizes a computer separate from the computer contained within the navigation system to input the route origin, route destination and departure time. This computer, which typically is a home computer, such as a PC, also enables the person planning the trip to input activities of interest that are desired during the trip. These activities of interest may include, for example, different types of restaurants, sporting activities, tourist attractions, cultural activities and the like.

After inputting not only the trip origin and destination but also the activities of interest, the computer searches a point of interest database for points of interest which match the activities of interest along the preferred route. Once such matches are identified, the computer wirelessly transmits the preferred route and the matching points of interest along the route to the navigation system. Typically, the computer is coupled to a network, such as the World Wide Web, which in turn is connected to a communication transmitter for transmitting this data to the navigation systems.

Upon receipt of the preferred route together with the points of interest which match the activities of interest inputted by the vehicle occupant, the route together with the points of interest are then displayed on the navigation system screen.

Consequently, since the computer is able to search the points of interest database for matches along the route between the origin and destination which match the activities of interest inputted by the person planning the trip, the entire trip experience and enjoyment is greatly enhanced.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a view illustrating the overall system architecture of the present invention;

FIG. 2 is a flowchart illustrating the trip planning process;

FIG. 3 is an exemplary screen display illustrating recommended points of interest along the route;

FIG. 4 is a diagrammatic view illustrating a preferred web server;

FIG. 5 is a table of the trip database;

FIG. 6 is a table illustrating the fields in a trace table;

FIG. 7 is a view illustrating the fields in a point of interest database;

FIG. 8 is a flowchart illustrating the method for updating the point of interest database to reflect visits by travelers; and

FIG. 9 is a flowchart illustrating the use of the point of interest database to display information to the user.

### DETAILED DESCRIPTION OF A PREFERRED EMBODIMENT OF THE PRESENT INVENTION

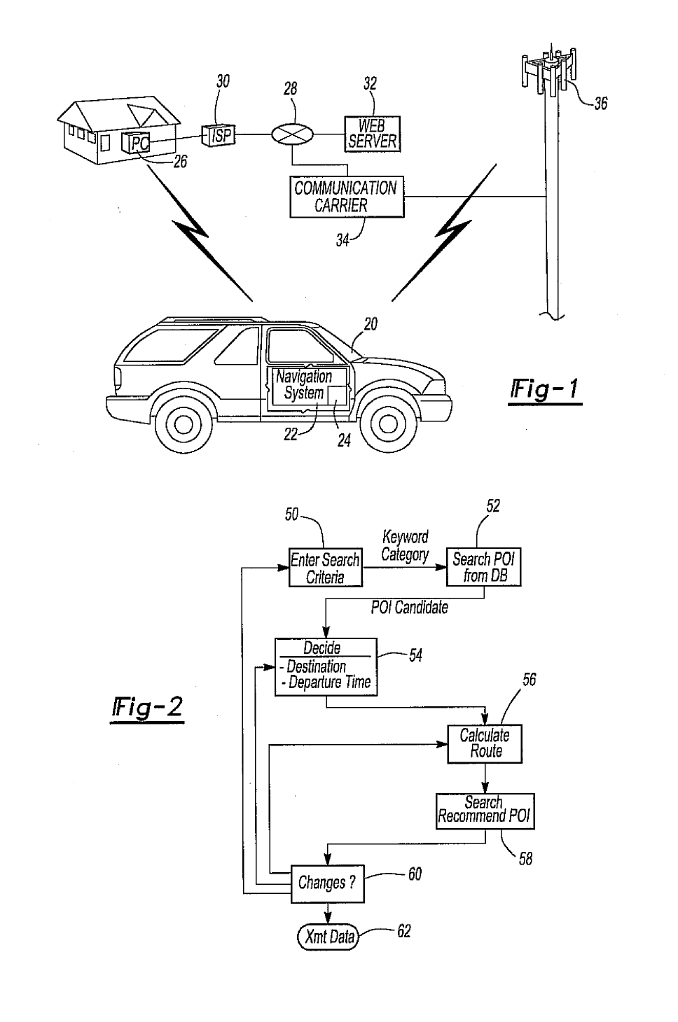

With reference first to FIG. 1, the system and method for route planning of an automotive vehicle 20 having a navigation system 22 is illustrated. The navigation system 22 is contained within the passenger compartment of the automotive vehicle 20 and is positioned so that it is visible to one or more occupants of the vehicle 20. The navigation system 22 also includes a display screen 24 for displaying the route and other information to the occupants of the vehicle 20.

The system of the present invention includes a computer 26, such as a home computer or home PC, and is separate from the processor contained within the navigation system 22. The computer 26 is of conventional construction and includes one or more input devices, such as a keyboard, joystick, mouse, etc., which enables the user of the computer 26 to input information to the computer 26.

The computer 26 communicates with a network 28, such as the World Wide Web or Internet, through an Internet service provider 30. Such service providers 30 typically use either dial-up or high-speed cable or DSL communications.

The network 28 communicates both with a web server 32, discussed more fully below, as well as a communication carrier 34. The communication carrier 34 is operatively connected with a wireless antenna 36, such as a cellular telephone tower, for wireless transmission to the navigation system 22. Consequently, the computer 26 communicates with the navigation system 22 through both the Internet 28, communications carrier 34 and antenna 36 to supply data to the navigation system 22.

In practice, the computer 26 is utilized by the person planning the route to input not only the origin and destination for the route and time of departure, but also activities that are of interest to the person traveling along the route. Such activities could include, for example, sporting events, nature parks, tourist attractions, restaurants and the like. With reference then to FIG. 2, a flowchart illustrating the route planning by the user is illustrated. At step 50, the user inputs search criteria indicative of activities of interest to the person taking the planned trip. These activities of interest comprise, for example, restaurants, sporting events, tourist attractions, etc. After the activities of interest have been entered at step 50, step 50 proceeds to step 52.

At step 52, the computer 26 searches a point of interest database to identify matches with the search criteria or activities of interest entered by the user at step 50. The point of interest database may be contained or downloaded to the computer 26, but more likely is accessible through the Internet 28 and web server 32. After the point of interest database has been searched, step 52 proceeds to step 54.

At step 54, the user enters the origin and destination of the trip as well as a desired departure time and date. Step 54 then proceeds to step 56 where the computer 26, utilizing either an internally contained algorithm or a web application, calculates the preferred route between the origin and destination of the planned trip. Typically, the preferred route calculated at step 52 comprises the quickest route between the origin and destination, although other preferred routes may optionally be calculated. Such optional routes may include, for example, a scenic route between the origin and destination even though the scenic route is not the quickest route between the origin and destination. After the route calculation at step 56, step 56 proceeds to step 58.

At step 58 the computer 26 searches the point of interest database identified at step 52. The point of interest database includes not only the identification of the point of interest itself, but also any customer recommendations regarding that point of interest. Furthermore, the point of interest resulting from the search at step 58 may be limited to a predetermined distance, e.g. ten miles, deviation from the preferred route. Step 58 then proceeds to step 60.

At step 60, the computer 26 displays the preferred route as well as the points of interest along the preferred route to the user or trip planner. The user is then given the opportunity to change the criteria if desired and to recalculate both the route as well as the search criteria for the various points of interest along the preferred route.

For example, step 60 may branch back to step 50 which enables the user to enter additional or revise existing activities of interest. After this is done, step 50 proceeds in the previously described fashion.

Alternatively, step 60 may branch back to step 54 which enables the user to reset the destination and origin as well as the departure times. For example, it may be desirable to reset the departure time for a particular trip in order to attend a particular sporting activity along the route. After the destination, origin or departure time has been revised at step 54, the planning proceeds in the previously described fashion.

Alternatively, the user may ignore certain recommendations made at step 60 after which step 60 branches back to step 56 to recalculate the route.

After the various revisions, if any, are made to the trip, and the recommendations made by the route planning software are acceptable to the user, step 60 branches to step 62 where the route, together with the recommended points of interest and any recommendations accompanying those points of interest, are transmitted through the communication carrier 34 (FIG. 1) and antenna 36 to the navigation system 22.

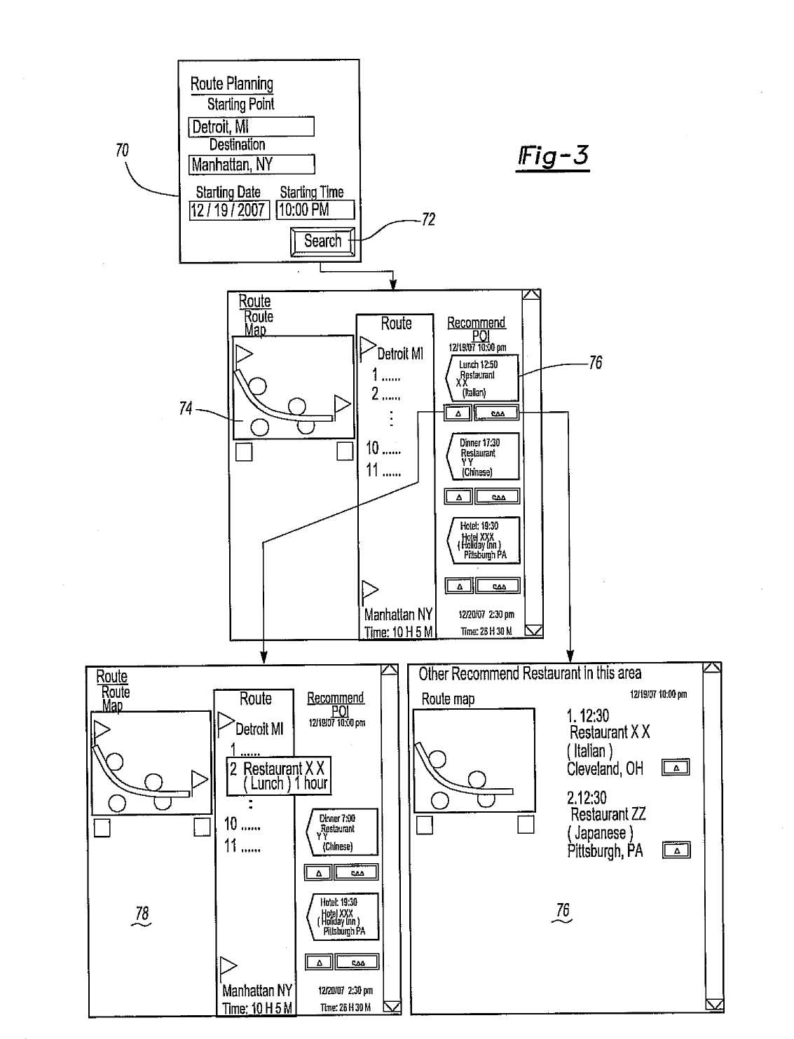

With reference now to FIG. 3, an exemplary display following the trip planning on the computer 26 is shown for an exemplary route between Detroit, Mich. and Manhattan, N.Y. which is displayed to the user on the navigation system screen 24. Upon depression of a search button 72, or other input means, the route may be displayed on the screen as shown at 74 together with recommended points of interest as shown at 76. Other points of interest are optionally displayed as shown at 76 upon user request. Similarly, a route recalculation including recommended points of interest may also be displayed as shown at 78.

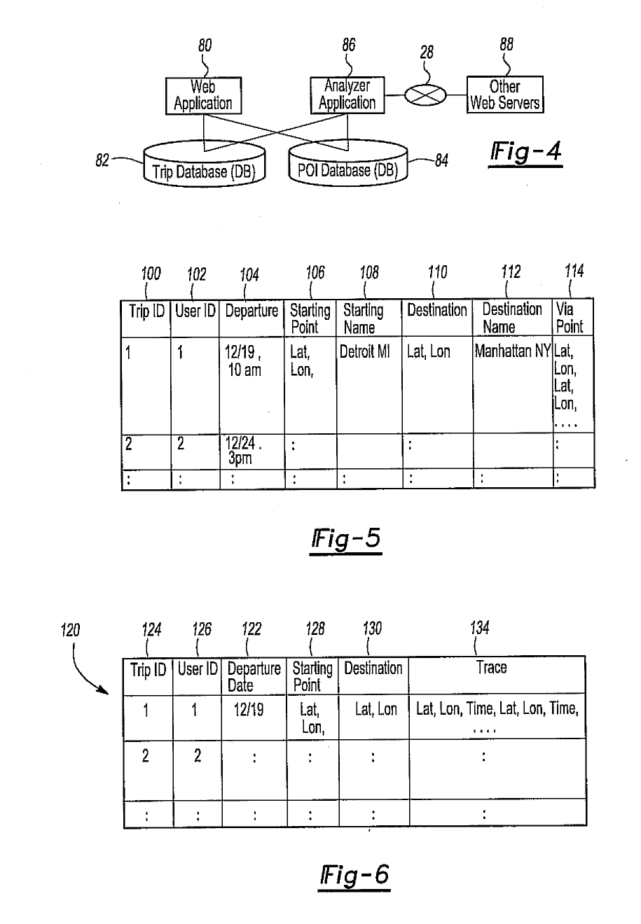

With reference now to FIG. 4, the web server 32 (FIG. 1) is shown in greater detail. The web server 32 includes a web application which controls the execution of the web server. The web application 80 has access both to a trip database 82, including a map database, and also a point of interest database 84. An analyzer application 86 searches the point of interest database for activities of interest inputted by the user and communicates the results of that search through the network 28 not only to other web servers 88, but also the communication carrier 34 (FIG. 1).

With reference now to FIG. 5, an exemplary planned trip table created by the computer 26 is shown. The table includes a trip ID as well as a user ID in fields 100 and 102, respectively. The trip ID and user ID in fields 100 and 102 enable multiple trips to be planned during one session with the computer 26.

For each trip, the table includes a departure date and time in field 104. The table also includes a starting point, identified by latitude and longitude, in field 106 as well as a text entry containing the name of the starting or origin point in field 108.

The table also includes a destination in field 110 specified by the latitude and longitude. The text name of the destination is also contained in the table in field 112.

If desired, intermediate points, specified by latitude and longitude for the trip between the origin and the destination, may also be contained within the trip table. These points are specified by latitude and longitude in field 114.

In many situations, it would be desirable to not only identify points of interest along the preferred route, but also to determine the level at which each point of interest is recommended by others. Furthermore, the number of visits to each point of interest in many cases is indicative of how highly recommended the particular point of interest, such as a restaurant, is viewed among other travelers. For example, a restaurant which enjoys many, many more visits by travelers would be likely to be more highly recommended than a restaurant that obtained a fewer number of customers.

With reference now to FIG. 6, most trips are unplanned trips, i.e. no particular destination has been entered by the operator of the automotive vehicle. For such unplanned trips a trace table illustrated in FIG. 6 is created which contains not only the departure date in field 122 for each different trip and user ID in fields 124 and 126, but also the starting point in latitude and longitude for each unplanned trip in field 128. The destination or end of the unplanned trip is maintained in field 130 of the trace table 120.

The trace table 120 also includes data in field 134 indicative of the route taken by the unplanned trip. This trace table is also indicative of where the automotive vehicle has traveled during each unplanned trip. Additionally, the trace table is uploaded to a server when the vehicle is in the vicinity of Internet or network conductivity, such as a wireless or cellular phone. When this occurs, the uploaded data will be stored within a master file of uploaded unplanned trip data database in the web server 32 containing the position of each vehicle for each unplanned trip.

With reference now to FIG. 7, the uploaded trace tables 120 can together form a recommended point of interest for various different types of points of interest. For example, one point of interest would be a restaurant point of interest table 140. The recommended restaurant point of interest table 140 includes various information, such as the restaurant name in field 142, category in field 144 and subcategory, i.e. the type of restaurant, in field 146. The restaurant point of interest table 140 also includes the location of the restaurant in field 148 by latitude and longitude.

The point of interest restaurant table 140 also includes information as to how recommended each restaurant based upon the number of visitors to that particular point of interest. For example, the number of users who considered the particular restaurant or point of interest at all may be maintained in field 150. This information may be further broken down by breakfast, lunch and dinner and that information stored in fields 152, 154 and 156 in the table 140.

The restaurant point of interest table 140 also includes the number of visitors, at least within a particular timeframe, in field 158. That information in turn may be subdivided into the number of visitors for breakfast, lunch and dinner in fields 160, 162 and 164, respectively.

It will be understood, of course, that the restaurant point of interest table illustrated in FIG. 7 is by way of example only and that other types of points of interest will likewise generate similar tables. For example, a different table format may be generated for a point of interest for hotels while still a different format may be utilized for a point of interest table for museums. In each case, however, the number of visitors within a selected timeframe (e.g. one year) is maintained within each table which pertains to the overall popularity of the particular point of interest.

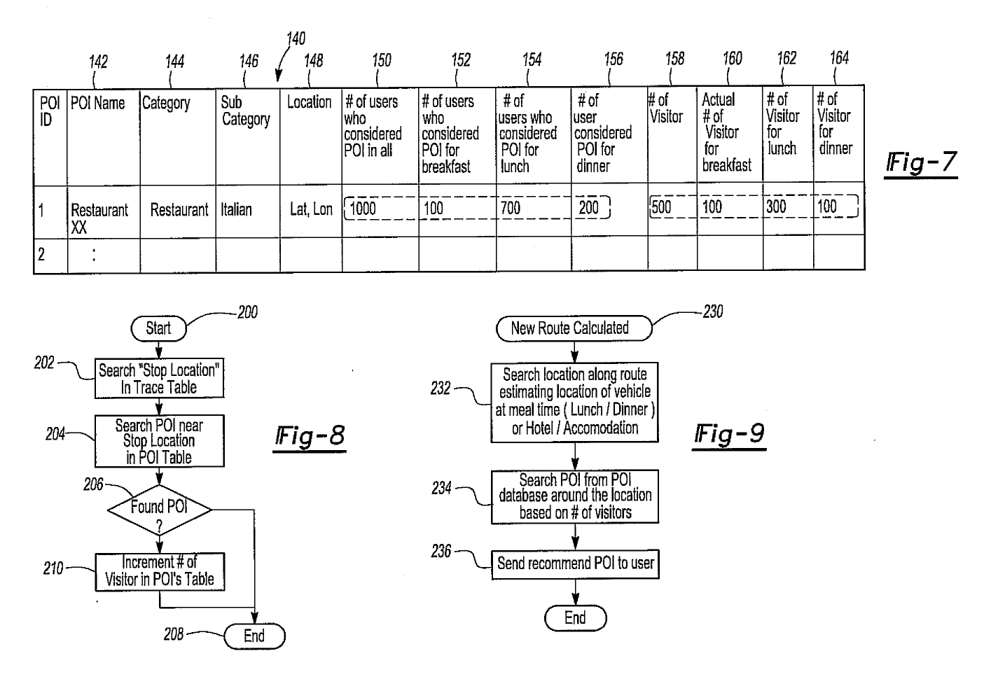

With reference now to FIG. 8, a flowchart is there shown illustrating how the point of interest database for all of the different points of interest and types of points of interest is updated. The flowchart starts at step 200 and proceeds to step 202 where the trace table (FIG. 6) is searched to determine the various locations at which the vehicle stopped. Step 202 then proceeds to step 204.

At step 204, the point of interest database is searched to determine if the stop location found at step 202 is near a point of interest within the table. Step 204 then proceeds to step 206.

If the point of interest is not found at step 204, step 206 branches to step 208 thus terminating the procedure. Otherwise, step 206 proceeds to step 210 which increments the number of visits that stop at a particular point of interest (FIG. 7).

With reference now to FIG. 9, the information contained for the number of visitors at the various points of interest within the database may be utilized by the operator of the navigation system in his or her selection of which point of interest to visit. After the route is calculated at step 230, step 230 then proceeds to step 232 where the navigation system estimates the location of the vehicle at a particular time, such as a mealtime. Step 232 then proceeds to step 234.

At step 234, the point of interest database is searched for points of interest meeting the search criteria at the estimated location of the vehicle at a particular time, such as a mealtime, determined at step 232. Thus, the information obtained at step 234 includes the number of visitors for each point of interest identified at step 232. Step 234 then proceeds to step 236.

Step 236 then provides a recommended point of interest to the user, e.g. by displaying the various points of interest on the vehicle navigation screen. For example, not only the point of interest but also the number of visitors for each point of interest may be displayed on the vehicle navigation screen thus identifying the popularity of the various points of interest as a of the number of visitors to each point of interest.

From the foregoing, it can be seen that the present invention provides a novel system and method for route planning which utilizes a home computer for route planning together with points of interest to enhance the overall travel experience. The present invention also provides a novel means of creating a point of interest database based upon the popularity of the various points of interest within the database.

Having described our invention, however, many modifications thereto will become apparent to those skilled in the art to which it pertains without deviation from the spirit of the invention as defined by the scope of the appended claims.

We claim:

1. A method for route planning for display on a screen of a vehicle navigation system comprising the steps of:
inputting a route origin and a route destination on a computer separate from the navigation system,
calculating a preferred route between said route origin and said route destination,
inputting activities of interest,
searching a point of interest database for point(s) of interest which match said activities of interest along said preferred route,
wirelessly transmitting said preferred route and said matching points of interest along said route to the navigation system, and
thereafter displaying said preferred route and said matching points of interest on the screen of the navigation system.

2. The method as defined in claim 1 wherein said wirelessly transmitting step comprises the step of wirelessly transmitting by a cellular telephone.

3. The method as defined in claim 1 and further comprising the step of updating said database when the vehicle containing the navigation system reaches any of said point(s) of interest in said database.

4. The method as defined in claim 1 wherein said step of inputting said route origin and said route destination comprises the step of inputting an anticipated departure time.

5. The method as defined in claim 1 wherein said displaying step further comprises the step of displaying alternate points of interest on the screen of the navigation system.

6. A system for route planning for display on a screen of a vehicle navigation system comprising:
a computer separate from the navigation system,
an input device which inputs a route origin, route destination and activities of interest to said computer,
said computer programmed to calculate a preferred route between said route origin and said route destination,
a database accessible by said computer containing points of interest,
said computer programmed to search said database for points of interest along the preferred route which match said activities of interest,
a transmitter which wirelessly transmits said preferred route and said points of interest along the preferred route which match said activities of interest to the navigation system for display on the screen of the navigation system.

7. The system as defined in claim 6 wherein said computer sends data to said transmitter through a network.

8. The system as defined in claim 7 wherein said network comprises the World Wide Web.

9. The system as defined in claim 6 wherein said transmitter comprises a cellular telephone transmitter.

10. The system as defined in claim 6 wherein said navigation system updates said database whenever the vehicle stops at a point of interest in the database.

11. The system as defined in claim 6 wherein said navigation system updates said database whenever the vehicle does not stop at a point which matched an activity of interest along the preferred route.

12. The system as defined in claim 6 wherein said computer is programmed to transmit alternate points of interest along the preferred route to the navigation system.

13. A method of developing a database for use with vehicle navigation systems which transmit a signal to a network indicative of the position of the vehicle, said method comprising the steps of:
storing records of points of interest, each record containing an identifier of the point of interest, a location of the point of interest and data relating to the point of interest,
receiving data from the navigation system,
analyzing said received data to determine if the vehicle is present at one of said points of interest in the database and, if so, updating the data of the record for said point of interest.

14. The method as defined in claim 13 wherein said updating step comprises the step of incrementing a counter the record of the point of interest.

15. The method as defined in claim 14 wherein said updating step comprises the step of storing a current time the vehicle was present at the point of interest.
